(19) United States
(12) Patent Application Publication
(10) Pub. No.: US 2023/0415813 A1
(43) Pub. Date: Dec. 28, 2023

(54) BRAKE APPARATUS AND CONTROLLING METHOD THEREOF

(71) Applicant: HL MANDO CORPORATION, Pyeongtaek-si (KR)

(72) Inventor: Namju JEON, Seoul (KR)

(21) Appl. No.: 18/213,672

(22) Filed: Jun. 23, 2023

(30) Foreign Application Priority Data
Jun. 28, 2022 (KR) 10-2022-0078771
Feb. 21, 2023 (KR) 10-2023-0022702

(51) Int. Cl. B62D 9/00; B60W 30/18; B60W 10/184; B60W 10/20; B60W 30/045

(52) U.S. Cl. CPC B62D 9/005; B60W 30/18145; B60W 10/184; B60W 10/20; B60W 30/045; B60W 2510/207; B60W 2520/14; B60W 2720/14; B60W 2710/20; B60W 2710/18

(57) ABSTRACT

A brake apparatus for a vehicle includes a brake and a processor configured to control the brake, and the processor is configured to receive a steering command including a steering direction from a steering apparatus of a vehicle, control the brake to provide a one-sided braking force to an inner wheel in the steering direction based on the receiving of the steering command, identify oversteering or understeering based on an output of a motion sensor of the vehicle, and control the brake to provide the one-sided braking force to an outer wheel in the steering direction based on the identifying of the oversteering.

### CROSS-REFERENCE TO RELATED APPLICATION

This application claims the benefit of Korean Patent Applications No. 10-2022-0078771, filed on Jun. 28, 2022, and No. 10-2023-0022702, filed on Feb. 21, 2023, in the Korean Intellectual Property Office, the disclosures of which are incorporated herein by reference.

### BACKGROUND

### 1. Field

Embodiments of the present disclosure relate to a brake apparatus capable of preventing oversteering by providing a one-sided braking force, and a controlling method thereof.

### 2. Description of the Related Art

A steering system for performing steering is essentially installed in a vehicle, and various types of steering systems have been suggested to improve steering performance.

Among the steering systems for vehicles, a steer-by-wire (SBW) system controls a traveling direction of a vehicle based on electrical signals reflecting a driver's steering wheel movement, instead of physically connecting a steering wheel and wheels.

The SBW system includes functions for preparing for system failure for safety of the driver and passengers, and the functions include a system redundancy function, a steer-by-brake function, and the like.

The steer-by-brake function is a function of turning a vehicle using a brake apparatus that performs braking, which is disclosed in Korean Patent Publication No.

However, the SBW system in the related art does not have a function for preparing for an understeering or oversteering situation that may occur while turning the vehicle through the steer-by-brake function in case of system failure.

When the understeering or oversteering situation occurs, the vehicle may deviate either inside or outside an ideal turning line. In order to prevent this, a function of limiting understeering and oversteering through one-sided braking when the SBW system fails may be provided.

### SUMMARY

Therefore, it is an aspect of the present disclosure to provide a brake apparatus capable of preventing understeering and oversteering by providing a one-sided braking force to a wheel on one side of a vehicle, and a controlling method thereof.

It is another aspect of the present disclosure to provide a brake apparatus capable of stably controlling turning of a vehicle without redundancy of a steering system in case of steering system failure, and a controlling method thereof.

Additional aspects of the disclosure will be set forth in part in the description which follows and, in part, will be obvious from the description, or may be learned by practice of the disclosure.

In accordance with one aspect of the present disclosure, a brake apparatus includes a brake and a processor configured to control the brake, wherein the processor is configured to receive a steering command including a steering direction from a steering apparatus of a vehicle, control the brake to provide a one-sided braking force to an inner wheel in the steering direction based on the receiving of the steering command, identify oversteering or understeering based on an output of a motion sensor of the vehicle, and control the brake to provide the one-sided braking force to an outer wheel in the steering direction based on the identifying of the oversteering.

The processor may be configured to receive the steering command when an error occurs in the steering apparatus.

The processor may be configured to determine a yaw rate desired by a driver of the vehicle based on the steering command and identify the oversteering or understeering based on a difference between a yaw rate of the vehicle and the yaw rate desired by the driver.

The processor may be configured to identify the oversteering based on the yaw rate difference that is greater than a preset first target yaw rate and identify the understeering based on the yaw rate difference that is smaller than a preset second target yaw rate.

The processor may be configured to change the first target yaw rate based on the one-sided braking force of the inner wheel.

The processor may be configured to increase the first target yaw rate based on an increase in the one-sided braking force of the inner wheel.

The processor may be configured to change the yaw rate desired by the driver of the vehicle based on the one-sided braking force of the inner wheel.

The processor may be configured to change the yaw rate desired by the driver so that the yaw rate difference is reduced.

The processor may be configured to reduce the yaw rate difference based on an increase in the one-sided braking force of the inner wheel.

The processor may be configured to determine a yaw moment of the vehicle based on the yaw rate desired by the driver and the yaw rate of the vehicle and determine the one-sided braking force provided to the inner wheel based on the yaw moment.

In accordance with another aspect of the present disclosure, a brake controlling method includes receiving a steering command including a steering direction from a steering apparatus of a vehicle, controlling a brake to provide a one-sided braking force to an inner wheel in the steering direction based on the receiving of the steering command, identifying oversteering or understeering based on an output of a motion sensor of the vehicle, and controlling the brake to provide the one-sided braking force to an outer wheel in the steering direction based on the identifying of the oversteering.

The brake controlling method may include receiving a steering command when an error occurs in the steering apparatus.

The brake controlling method may include determining a yaw rate desired by a driver of the vehicle based on the steering command and identifying the oversteering or understeering based on a difference between a yaw rate of the vehicle and the yaw rate desired by the driver.

The brake controlling method may include identifying the oversteering based on the yaw rate difference that is greater than a preset first target yaw rate and identifying the understeering based on the yaw rate difference that is smaller than a preset second target yaw rate.

The brake controlling method may include changing the first target yaw rate based on the one-sided braking force of the inner wheel.

The brake controlling method may include increasing the first target yaw rate based on an increase in the one-sided braking force of the inner wheel.

The brake controlling method may include changing the yaw rate desired by the driver of the vehicle based on the one-sided braking force of the inner wheel.

The brake controlling method may include changing the yaw rate desired by the driver so that the yaw rate difference is reduced.

The brake controlling method may include reducing the yaw rate difference based on an increase in the one-sided braking force of the inner wheel.

The brake controlling method may include determining a yaw moment of the vehicle based on the yaw rate desired by the driver and the yaw rate of the vehicle; and determining the one-sided braking force provided to the inner wheel based on the yaw moment.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a control configuration of a brake apparatus in accordance with one embodiment;

FIG. 2 illustrates a one-sided braking force provided in a situation in which understeering of the brake apparatus in accordance with one embodiment is identified;

FIG. 3 illustrates a one-sided braking force provided in a situation in which oversteering of the brake apparatus in accordance with one embodiment is identified;

FIG. 4 is a diagram for describing a one-sided braking control of the brake apparatus in accordance with one embodiment; and

FIG. 5 illustrates a control operation of the brake apparatus in accordance with one embodiment.

### DETAILED DESCRIPTION

Like reference numerals refer to like elements throughout the specification. Not all elements of embodiments will be described in the specification, and general information in the technical field to which the present disclosure pertains or overlapping information between the embodiments will be omitted. The terms “part,” “module,” “member,” or “block” as used throughout the specification may be implemented in software or hardware, and a plurality of “parts,” “modules,” “members,” or “blocks” may be implemented in a single component, or a single “part,” “module,” “member,” or “block” may include a plurality of components.

It will be understood that when a component is referred to as being “connected” to another component throughout the specification, it can be directly or indirectly connected to the other component. When a component is indirectly connected to another component, it may be connected to the other component through a wireless communication network.

In addition, when a part “includes” or “comprises” a component, unless described to the contrary, the term “includes” or “comprises” does not indicate that the part excludes another component but instead indicates that the part may further include the other component.

In the entire specification, when a member is said to be located “on” another member, this includes not only a case where a member is in contact with another member, but also a case where another member exists between the two members.

Terms such as first, second, etc., are used to distinguish one component from another component, and the components are not limited by the above-described terms.

Unless the context clearly indicates otherwise, the singular forms include the plural forms.

In each operation, identification codes are used for convenience of description but are not intended to illustrate the order of the operations, and each operation may be implemented in an order different from the illustrated order unless explicitly stated in the context.

Hereinafter, a working principle and embodiments of the present disclosure will be described with reference to the accompanying drawings.

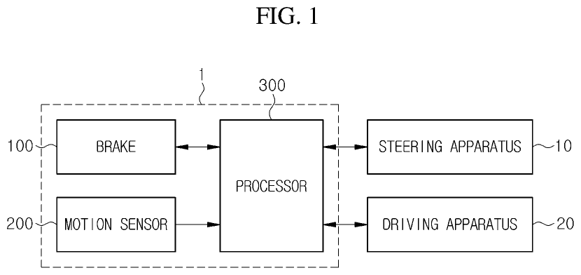

FIG. 1 illustrates a control configuration of a brake apparatus in accordance with one embodiment.

Referring to FIG. 1, a brake apparatus 1 may include a brake 100, a motion sensor 200, and a processor 300. Components illustrated in FIG. 1 do not correspond to essential components of the brake apparatus 1, and at least some of them may be omitted.

The brake 100 reduces a rotational speed of wheels of a vehicle by providing a braking force to the wheels, and may be, for example, a caliper-type brake or a drum-type brake.

The brake 100 may be provided on each of the wheels of the vehicle, and the vehicle may be steered through one-sided braking performed by operating only some of the brakes 100 provided on the wheels or operating the brakes 100 with different braking forces.

The brake 100 may receive an electrical signal corresponding to the braking force applied to one or more wheels of the vehicle from the processor 300, and provide the braking force to the one or more wheels corresponding thereto.

The motion sensor 200 refers to a sensor that measures a state of the vehicle, and may include, for example, a wheel speed sensor, a yaw rate sensor, and the like of the vehicle. The wheel speed sensor may be provided at each of the wheels of the vehicle to measure a speed of each wheel. The yaw rate sensor may measure a yaw rate, which is the degree of rotation of the front of the vehicle around a Z-axis.

The motion sensor 200 may measure a sensing voltage applied to each sensor and provide an electrical signal corresponding to the measured sensing voltage to the processor 300.

The motion sensor 200 may measure a sensing current applied to each sensor and provide an electrical signal corresponding to the measured sensing current to the processor 300.

The processor 300 provides a control signal for controlling an operation of the brake apparatus 1.

The processor 300 may include one or two or more processing elements or one or two or more processing cores, and may be variously called a micro controller unit (MCU).

The processor 300 may be electrically connected to the steering apparatus and receive a steering command from the steering apparatus 10 based on the received driver's steering wheel operation. The steering command may include a steering direction (e.g., steering angle), a steering speed, and/or a steering acceleration.

The steering apparatus 10 may include one or more steering sensors of the vehicle, for example, a steering angle sensor. The steering apparatus 10 may provide an electrical signal corresponding to information measured through one or more steering sensors to the processor 300.

The steering angle sensor may measure an angle of rotation of the steering wheel by the user's steering wheel operation. The steering angle sensor may measure, for example, a change in voltage generated when a slit plate rotating with the steering operation passes or blocks light emitted from an optical device and provide an electrical signal corresponding to the measured change in voltage to the processor 300.

The steering apparatus 10 may correspond to, for example, a steer-by-wire (SBW) system that controls a wheel direction of the vehicle based on the electrical signal corresponding to the angle of rotation of the steering wheel by the driver.

The steering apparatus 10 may provide the steering command to the processor 300 so that stable turning control is performed when an error occurs in all or part of the existing system.

The processor 300 may determine a one-sided braking force to be provided to an inner wheel in the steering direction based on the steering command received from the steering apparatus 10.

For example, the processor 300 may determine a yaw moment based on the yaw rate of the vehicle received from the motion sensor 200 and the steering angle received from the steering apparatus 10 and determine the one-sided braking force to be provided to the inner wheel in the steering direction of the vehicle according to the determined yaw moment.

The processor 300 may provide the brake 100 with a control signal for providing the one-sided braking force to the inner wheel in the steering direction of the vehicle. Accordingly, the brake 100 may output an operation signal that causes the brake mounted on the inner wheel in the steering direction to apply the braking force to the wheel.

The processor 300 may determine a driving force to be provided to a driving apparatus 20 based on the one-sided braking force to be provided to the inner wheel in the steering direction of the vehicle. The driving apparatus 20 is an apparatus that outputs a driving force to the vehicle, and may include, for example, an engine.

The processor 300 may provide a control signal for providing the driving force to the driving apparatus 20.

The processor 300 may identify oversteering or understeering based on an output of the motion sensor 200 of the vehicle.

Oversteering refers to a phenomenon in which the vehicle is pulled inwardly from an ideal turning line when the vehicle is turned even though the steering wheel is properly turned. The oversteering may be caused by over control of the one-sided braking of the vehicle, tire wear, small frictional force on the road surface, sharp turns, sudden braking, and the like.

Understeering refers to a phenomenon in which the vehicle is pushed outwardly from the ideal turning line when the vehicle is turned even though the steering wheel is sufficiently turned. The understeering may be caused by high speed and the like.

The processor 300 may provide the brake 100 with an electrical signal corresponding to the one-sided braking force to be provided to the inner wheel in the steering direction based on the identification of the understeering. The processor 300 may alleviate the understeering of the vehicle by, for example, increasing the one-sided braking force provided to the inner wheel in the steering direction through the brake 100.

The processor 300 may provide the brake 100 with an electrical signal corresponding to a one-sided braking force to be provided to an outer wheel in the steering direction based on the identification of the oversteering. The processor 300 may alleviate the oversteering of the vehicle by, for example, providing the one-sided braking force to the outer wheel in the steering direction through the brake 100.

The brake apparatus 1 may include a memory (not illustrated) for storing or recording programs and/or data for controlling operations of the processor 300 and the brake apparatus 1.

The memory (not illustrated) may include one or two or more memory elements or one or two or more registers.

The memory (not illustrated) may store or record a program and/or data for controlling the operation of the brake 100 based on a received user input. The memory (not illustrated) may provide programs and/or data to the processor 300 and store temporary data generated during an arithmetic operation of the processor 351.

The memory (not illustrated) may include, for example, a volatile memory such as a static random access memory (S-RAM) and a dynamic random access memory (D-RAM) and a non-volatile memory such as a read only memory (ROM), an erasable programmable read only memory (EPROM), and a flash memory.

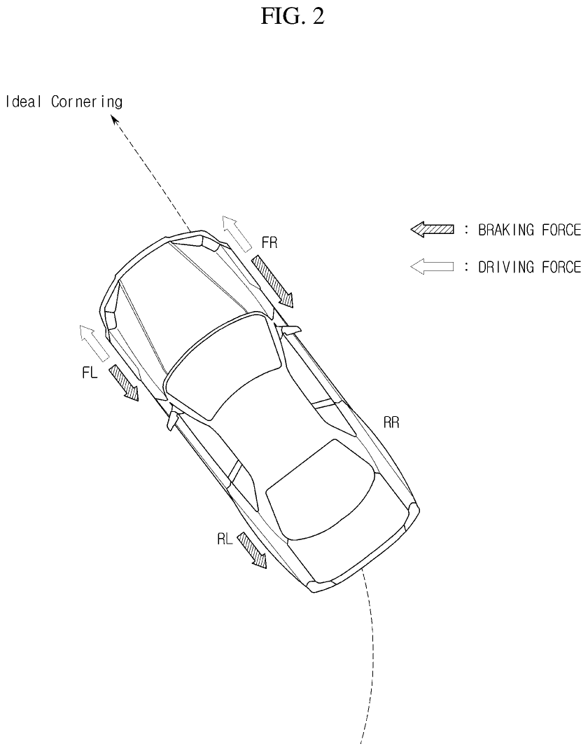

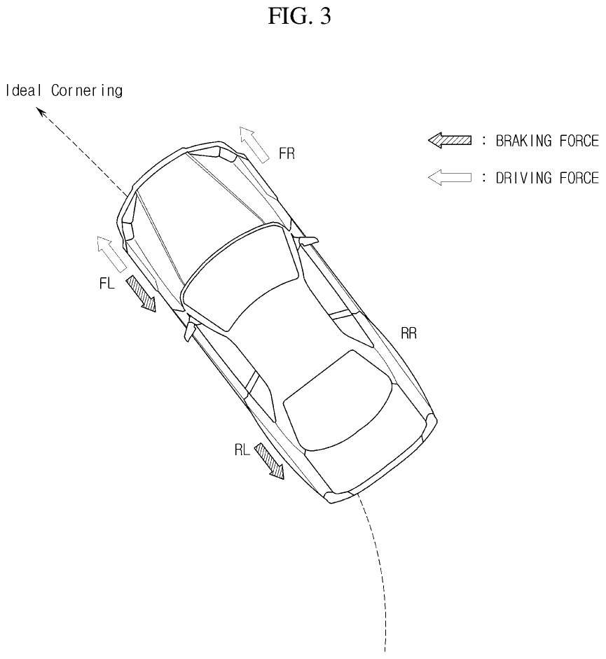

FIG. 2 illustrates a one-sided braking force provided in a situation in which understeering of the brake apparatus in accordance with one embodiment is identified. FIG. 3 illustrates a one-sided braking force provided in a situation in which oversteering of the brake apparatus in accordance with one embodiment is identified.

Referring to FIGS. 2 and 3, the processor 300 may provide the brake 100 with an electrical signal corresponding to the one-sided braking force to cause the vehicle to travel in the steering direction when an error occurs in the steering apparatus 10.

For example, the processor 300 may provide a control signal to the brake 100 to provide the one-sided braking force to left wheels FL and RL based on the steering command received from the steering apparatus 10 when the vehicle turns left, and provide a control signal to the driving apparatus 20 to provide a driving force to an engine for main drive wheels FL and FR.

In this process, the processor 300 may determine whether the vehicle is moving along an ideal cornering based on the steering command received from the steering apparatus 10 and/or an output signal of the motion sensor 200, and the processor 300 may identify whether the understeering and/or oversteering occurs in the vehicle based on the determination.

As illustrated in FIG. 2, when the understeering is identified when the vehicle turns left, the processor 300 may provide a control signal to the brake 100 to increase the one-sided braking force previously provided to the inner wheels FL and RL in the steering direction to turn the vehicle. Further, when the understeering is identified when the vehicle turns left, the processor 300 may provide a control signal to the driving apparatus 20 to reduce the driving force previously provided to the main drive wheels FL and FR.

As illustrated in FIG. 3, when the oversteering is identified when the vehicle turns left, the processor 300 may provide a control signal to the brake 100 to provide the one-sided braking force to the outer wheel FR in the steering direction. Further, when the oversteering is identified when the vehicle turns left, the processor 300 may provide a control signal to the driving apparatus 20 to reduce the driving force previously provided to the main drive wheels FL and FR.

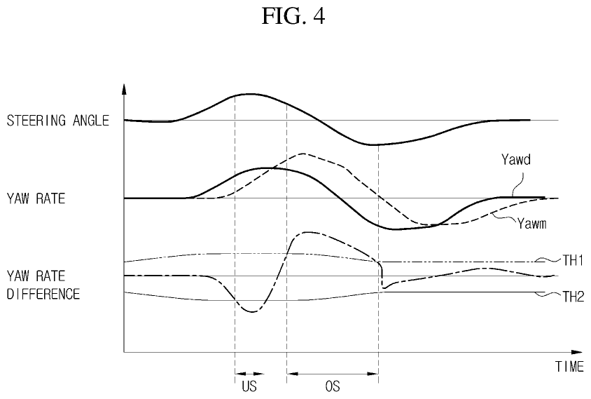

FIG. 4 is a diagram for describing one-sided braking control of the brake apparatus in accordance with one embodiment.

Referring to FIG. 4, the processor 300 may identify an electrical signal corresponding to the steering angle included in the steering direction through the steering command received from the steering apparatus 10.

The processor 300 may determine a yaw rate yawd desired by the driver of the vehicle based on the steering command of the steering apparatus 10. The processor 300 may determine the yaw rate yawd desired by the driver based on an electrical signal corresponding to the steering direction, for example, the steering angle caused by the driver's steering wheel operation.

The processor 300 may determine an actual yaw rate yawm of the vehicle based on an electrical signal output from the yaw rate sensor (not illustrated) of the motion sensor 200.

The processor 300 may determine the yaw moment of the vehicle based on the yaw rate yawd desired by the driver and the yaw rate yawm of the vehicle.

The processor 300 may determine the yaw moment based on, for example, a first yaw moment according to feed-forward control based on the yaw rate yawd desired by the driver (yawd*Pgain_FF, where Pgain_FF is a feed-forward P gain) and a second yaw moment according to feed-back control based on a difference between the yaw rate yawd desired by the driver and the yaw rate yawm of the vehicle ((Yawc−Yawm)×Pgain_FB+∫(Yawc−Yawm)×Igain_FB, where Pgain_FB is a feed-back P gain and Igain_FB is a feed-back I gain).

The processor 300 may calculate a target pressure for one-sided braking based on the yaw moment, identify whether the vehicle turns left or right based on the target pressure, and select a wheel for the one-sided braking.

The processor 300 may determine the one-sided braking force provided to the inner wheel based on the yaw moment.

The processor 300 may determine a yaw rate difference based on the comparison between the yaw rate yawd desired by the driver and the yaw rate yawm of the vehicle, and identify understeering US or oversteering OS based on the yaw rate difference.

The processor 300 may identify the oversteering OS based on the yaw rate difference that is greater than a preset first target yaw rate TH1 and identify the understeering US based on the yaw rate difference that is smaller than a preset second target yaw rate TH2.

The processor 300 may change the first target yaw rate TH1 based on the one-sided braking force provided to the inner wheel in the steering direction. For example, the processor 300 may determine a first target yaw rate compensation value based on the total sum of one-sided braking torque provided to the inner wheel in the steering direction and reflect the first target yaw rate compensation value to the first target yaw rate TH1.

The processor 300 may increase the first target yaw rate TH1 based on an increase in the one-sided braking force of the inner wheel in the steering direction.

For example, the processor 300 may increase a first target yaw rate compensation value C_TH1 based on an increase in the total sum of the one-sided braking torque provided to the inner wheel in the steering direction.

The processor 300 may change the yaw rate yawd desired by the driver based on the one-sided braking force of the inner wheel in the steering direction. For example, the processor 300 may determine a yaw rate compensation value desired by the driver based on the total sum of the one-sided braking torque provided to the inner wheel in the steering direction and reflect the yaw rate compensation value to the yaw rate yawd desired by the driver.

The processor 300 may change the yaw rate yawd desired by the driver so that the yaw rate difference between the yaw rate yawd desired by the driver and the yaw rate yawm of the vehicle is reduced.

For example, when it is identified that the vehicle turns left, the processor 300 may make a determination so that the yaw rate yawd desired by the driver is increased or reduced based on the yaw rate compensation value, thereby making determination so that the yaw rate difference is reduced. Further, when it is identified that the vehicle turns right, the processor 300 may make a determination so that the yaw rate yawd desired by the driver is reduced or increased based on the yaw rate compensation value, thereby making a determination so that the yaw rate difference is reduced.

The processor 300 may reduce the yaw rate difference based on the increase in the one-sided braking force of the inner wheel in the steering direction. For example, the processor 300 may increase the yaw rate compensation value desired by the driver so that the yaw rate difference is reduced based on the increase in the total sum of the one-sided braking torque provided to the inner wheel in the steering direction.

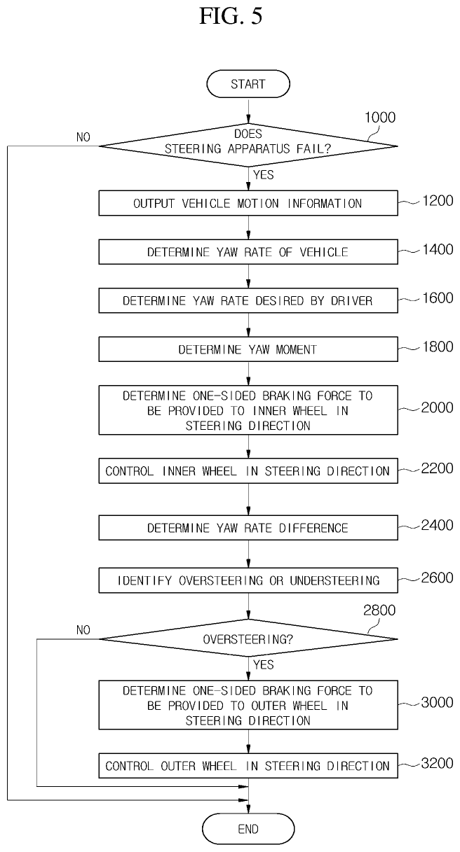

FIG. 5 illustrates a control operation of the brake apparatus in accordance with one embodiment.

Referring to FIG. 5, the processor 300 may receive a steering command from the steering apparatus 10 and identify whether the steering apparatus 10 fails (1000).

When the processor 300 receives the steering command and identifies that the steering apparatus 10 fails, the processor 300 may receive vehicle motion information output from the motion sensor 200 (1200).

The processor 300 may determine a yaw rate yawm of the vehicle based on the vehicle motion information (1400).

The processor 300 may determine a yaw rate yawd desired by the driver based on the steering command (1600).

The processor 300 may determine a yaw moment based on the yaw rate yawm of the vehicle and/or the yaw rate yawd desired by the driver (1800).

The processor 300 may output a first one-sided braking control signal corresponding to a one-sided braking force to be provided to the inner wheel in the steering direction based on the determined yaw moment and provide the first one-sided braking control signal to the brake 100 (2000).

The brake 100 may operate to generate a braking force corresponding to the first one-sided braking control signal received from the processor 300 (2200).

The processor 300 may identify whether the vehicle turning according to the first one-sided braking control signal is oversteering or understeering based on a comparison between the yaw rate yawd desired by the driver and the actual yaw rate yawm of the vehicle (2400, 2600).

When the oversteering is identified, the processor 300 may output a second one-sided braking control signal corresponding to the one-sided braking force to be provided to the outer wheel in the steering direction and provide the second one-sided braking control signal to the brake 100 (2800, 3000). In contrast, when the understeering is identified, the processor 300 may not determine the one-sided braking force to be provided to the outer wheel in the steering direction, and may output a second one-sided braking control signal corresponding to the one-sided braking force to be provided to the inner wheel and provide the second one-sided braking control signal to the brake 100 (not illustrated).

The brake 100 may operate to generate a braking force corresponding to the second one-sided braking control signal received from the processor 300 (3200).

As described above, the brake apparatus 1 may provide the one-sided braking force to the wheels of the vehicle in response to the steering command according to an error of the steering apparatus 10. In addition, the brake apparatus 1 may provide the one-sided braking force to the inner wheel in the steering direction based on the steering direction of the vehicle to turn the vehicle. In the process of turning the vehicle according to the one-sided braking force, when understeering is identified, the one-sided braking force provided to the inner wheel in the steering direction may be controlled, and when oversteering is identified, the one-sided braking force may be provided to the outer wheel in the steering direction.

In accordance with one aspect of the present disclosure, it is possible to provide a brake apparatus and a controlling method thereof for providing a one-sided braking force to an outer wheel in a steering direction of a vehicle only in an oversteering situation when steer-by-brake using the brake apparatus is performed. Accordingly, stable turning performance can be provided even in case of steering system failure that may occur while the vehicle is traveling.

In accordance with one aspect of the present disclosure, it is possible to control a vehicle to stably turn without redundancy of a steering system by performing one-sided braking control on vehicle wheels in case of steering system failure.

Effects of the present disclosure are not limited to those mentioned above, and other effects not mentioned will be clearly understood by those skilled in the art from the description of claims.

As above, the disclosed exemplary embodiments have been described with reference to the accompanying drawings. It will be understood by those skilled in the art that various changes in form and details may be made therein without departing from the spirit and scope of the disclosure as defined by the appended claims and their equivalents. The disclosed embodiments are illustrative and should not be construed as limiting.

What is claimed is:

1. A brake apparatus comprising:
a brake; and
a processor configured to control the brake,
wherein the processor is configured to:
receive a steering command including a steering direction from a steering apparatus of a vehicle;
control the brake to provide a one-sided braking force to an inner wheel in the steering direction based on the receiving of the steering command;
identify oversteering or understeering based on an output of a motion sensor of the vehicle; and
control the brake to provide the one-sided braking force to an outer wheel in the steering direction based on the identifying of the oversteering.

2. The brake apparatus according to claim 1, wherein the processor is configured to receive a steering command when an error occurs in the steering apparatus.

3. The brake apparatus according to claim 1, wherein the processor is configured to:
determine a yaw rate desired by a driver of the vehicle based on the steering command; and
identify the oversteering or understeering based on a difference between a yaw rate of the vehicle and the yaw rate desired by the driver.

4. The brake apparatus according to claim 3, wherein the processor is configured to:
identify the oversteering based on the yaw rate difference that is greater than a preset first target yaw rate; and
identify the understeering based on the yaw rate difference that is smaller than a preset second target yaw rate.

5. The brake apparatus according to claim 4, wherein the processor is configured to change the first target yaw rate based on the one-sided braking force of the inner wheel.

6. The brake apparatus according to claim 5, wherein the processor is configured to increase the first target yaw rate based on an increase in the one-sided braking force of the inner wheel.

7. The brake apparatus according to claim 3, wherein the processor is configured to change the yaw rate desired by the driver of the vehicle based on the one-sided braking force of the inner wheel.

8. The brake apparatus according to claim 7, wherein the processor is configured to change the yaw rate desired by the driver so that the yaw rate difference is reduced.

9. The brake apparatus according to claim 8, wherein the processor is configured to reduce the yaw rate difference based on an increase in the one-sided braking force of the inner wheel.

10. The brake apparatus according to claim 3, wherein the processor is configured to:
determine a yaw moment of the vehicle based on the yaw rate desired by the driver and the yaw rate of the vehicle; and
determine the one-sided braking force provided to the inner wheel based on the yaw moment.

11. A brake controlling method comprising:
receiving a steering command including a steering direction from a steering apparatus of a vehicle;
controlling a brake to provide a one-sided braking force to an inner wheel in the steering direction based on the receiving of the steering command;
identifying oversteering or understeering based on an output of a motion sensor of the vehicle; and
controlling the brake to provide the one-sided braking force to an outer wheel in the steering direction based on the identifying of the oversteering.

12. The brake controlling method according to claim 11, comprising receiving a steering command when an error occurs in the steering apparatus.

13. The brake controlling method according to claim 11, comprising:
determining a yaw rate desired by a driver of the vehicle based on the steering command; and
identifying the oversteering or understeering based on a difference between a yaw rate of the vehicle and the yaw rate desired by the driver.

14. The brake controlling method according to claim 13, comprising:
identifying the oversteering based on the yaw rate difference that is greater than a preset first target yaw rate; and
identifying the understeering based on the yaw rate difference that is smaller than a preset second target yaw rate.

15. The brake controlling method according to claim 14, comprising changing the first target yaw rate based on the one-sided braking force of the inner wheel.

16. The brake controlling method according to claim 15, comprising increasing the first target yaw rate based on an increase in the one-sided braking force of the inner wheel.

17. The brake controlling method according to claim 13, comprising changing the yaw rate desired by the driver of the vehicle based on the one-sided braking force of the inner wheel.

18. The brake controlling method according to claim 17, comprising changing the yaw rate desired by the driver so that the yaw rate difference is reduced.

19. The brake controlling method according to claim 18, comprising reducing the yaw rate difference based on an increase in the one-sided braking force of the inner wheel.

20. The brake controlling method according to claim 13, comprising:
determining a yaw moment of the vehicle based on the yaw rate desired by the driver and the yaw rate of the vehicle; and
determining the one-sided braking force provided to the inner wheel based on the yaw moment.
